(19) United States
(12) Patent Application Publication
(10) Pub. No.: US 2012/0099698 A1
(43) Pub. Date: Apr. 26, 2012

(54) BRUSH WITH BRUSH ELEMENTS FOR TRANSMITTING CURRENT AT A SLIDING SURFACE

(76) Inventors: Thomas Luthardt, Bamberg (DE); Helmut Repp, Erlangen (DE)

(21) Appl. No.: 13/277,877

(22) Filed: Oct. 20, 2011

(30) Foreign Application Priority Data
Oct. 21, 2010 (DE) 10 2010 042 764.0

(51) Int. Cl. H05G 1/60

(52) U.S. Cl. 378/4; 439/32

(57) ABSTRACT

One embodiment includes a brush for transmitting current at a sliding surface between gantry parts of a medical imaging system moving relative to one another. The brush includes brush elements that are designed and/or arranged such that the brush elements contact the sliding surface spaced apart from one another. Ends of the brush elements touch the sliding surface separately from one another.

This application claims the benefit of DE 10 2010 042 764.0, filed on Oct. 21, 2010.

### BACKGROUND

The present embodiments relate to a brush with spaced brush elements for transmitting current at a sliding surface.

Brushes for effecting a sliding contact between two moving components are used in many areas of technology. Brushes are, for example, also used in computed tomography systems that include a stationary structure, radiation sources, and detectors rotating about the patient. The transmission of data or energy between the moving part and the stationary part is effected, for example, with a sliding-action contact.

In such arrangements, there may be a lubricant between parts moving relative to one another. During operation of a sliding contact arrangement, the brushes will be abraded. The abrasion consists of small particles that are abraded when the brush slides or grinds.

Lubricant and abrasion may have a negative effect on the brushes used. For example, the operability of brushes of standard brush contact pick-offs is impaired over time. Because of the lubricant or the mixture of abrasion and lubricant, the elasticity of the brushes is reduced over time. As a result, the sliding-action contact system reacts significantly more sensitively to unevennesses in the slide track, and the signal quality deteriorates. For this reason, the brushes used may be overdimensioned for the currents and voltages. This overdimensioning, for example by increasing the wire diameter of wires, with which the brushes are formed, results in disadvantages (e.g., a deterioration of dynamic properties because of a higher mass of the brush).

Comparable problems are addressed in the publications DE 195 43 383 B4, DE 198 17 796 C2 and DE 102 007 054 675 A1. The publications primarily describe options for preventing the negative consequences of the abrasion (e.g., using an arresting device according to DE 195 43 383 B4 or DE 102 007 054 675 A1 or by design measures in accordance with DE 198 17 796 C2).

### SUMMARY AND DESCRIPTION

The present embodiments may obviate one or more of the drawbacks or limitations in the related art. For example, a brush providing a robust contact in the case of small currents and high grinding velocities may be provided.

The present embodiments include a brush for transmitting current at a sliding surface between gantry parts of an imaging medical system moving relative to one another. The brush includes brush elements that are designed and/or arranged such that the brush elements contact the sliding surface spaced apart from one another. In other words, the brush elements strike the sliding surface separately. The present embodiments offer the advantage that unevennesses and blemishes on the sliding surface (e.g., on a slide track of a slip ring) may be offset even at a high slide velocity of the brush. The contact to a slide track is improved, since more brush elements are engaged than in the prior art.

In one embodiment, the brush elements may resemble fibers. Each of the brush elements has a first end and a second end, the first ends being spaced apart from one another.

In another embodiment, the brush may include a mount, in which the brush elements are arranged.

The second ends may be arranged in the mount.

In one embodiment, the brush may have holes in the mount spaced apart from one another. The second ends of the brush elements are fixed in the holes. As a result, a separation of the brush elements is achieved.

In a further embodiment, the brush elements may be corrugated. As a result of the corrugation, a separation of the brush elements at a sliding surface is achieved.

The brush may be cylindrical or cuboidal.

In one embodiment, a computed tomography system with a fixed gantry part and a rotatable gantry part is provided with a brush of the present embodiments.

### BRIEF DESCRIPTION OF THE DRAWINGS

FIG. 1 shows a brush contact arrangement according to the prior art;

FIG. 2 shows a brush with spring retainer according to the prior art;

FIG. 3 shows a side view of one embodiment of a brush with brush elements spaced apart from one another;

FIG. 4 shows a top view of one embodiment of a brush with brush elements spaced apart from one another;

FIG. 5 shows a side view of one embodiment of a brush with corrugated brush elements; and

FIG. 6 shows a top view of one embodiment of a brush with corrugated brush elements.

### DETAILED DESCRIPTION OF THE DRAWINGS

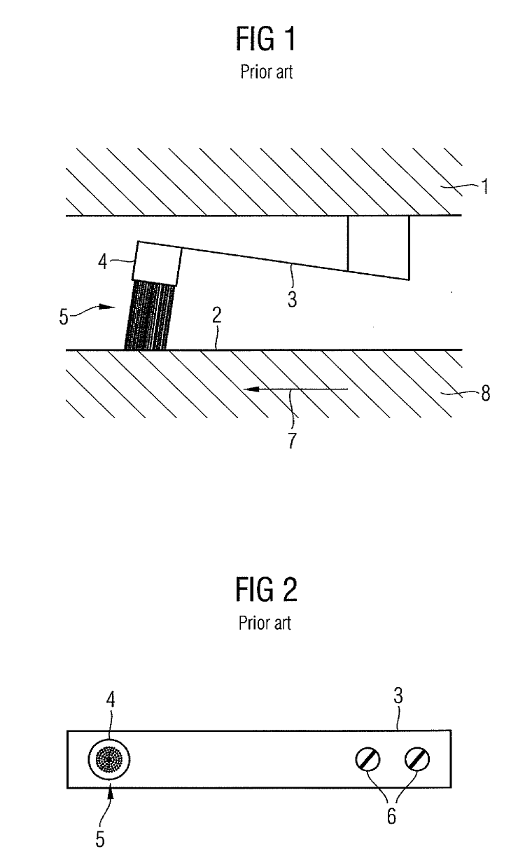

FIG. 1 shows a brush contact arrangement according to the prior art in cross-section. A spring bracket 3 (e.g., a spring retainer) is arranged at a first part 1. The spring bracket 3 has a brush 5 with a mount 4. The brush 5 contacts a slide track 2 of a second part 8. The second part 8 moves relative to the first part 1. Such brushes may include, for example, approximately 600-1900 fibers. The second part 8 moves in direction 7. In a computed tomography system, the first part 1 supporting the brush 5 may be stationary, whereas the second part 8 rotates.

FIG. 2 shows a top view of a brush 5 with a mount 4 according to the prior art. The brush 5 is attached to a spring retainer 3. The spring retainer 3 is attached using fastening points 6 to a first part (not shown).

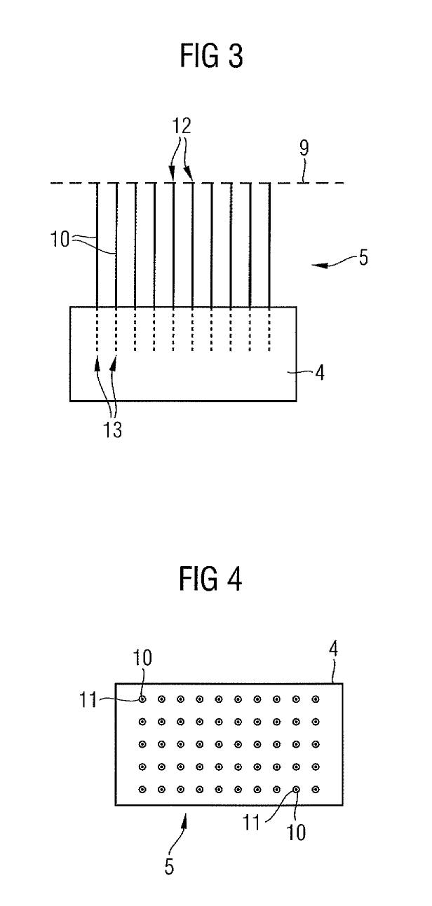

FIG. 3 shows one embodiment of a brush 5 in a side view. The brush 5 includes a plurality of fiber-like brush elements 10 (e.g., brush elements) that are arranged in a mount 4 such that first ends 12 of the brush elements 10 are spaced apart from one another. In other words, the brush elements 10 are arranged separately when contacting a sliding surface 9. Second ends 13 of the brush elements 10 are fixed in the mount 4 of the brush 5.

FIG. 4 shows a top view of one embodiment of a brush 5. A plurality of fiber-like brush elements 10 is fixed in holes 11 in a cuboidal mount 4 of the brush 5. Each of the holes 11 accommodates one brush element 10. As a result, the brush elements 10 at an end facing away from the mount 4 are spaced apart from one another. This thus effects a separation of the brush elements 10.

FIG. 5 shows one embodiment of a brush 5 with corrugated brush elements 10 in a side view. The brush 5 includes a plurality of fiber-like brush elements 10 that are corrugated such that first ends 12 of the brush elements 10 are spaced apart from one another. In other words, the brush elements 10 are separated when contacting a sliding surface 9. Second ends 13 of the brush elements 10 are fixed in a mount 4.

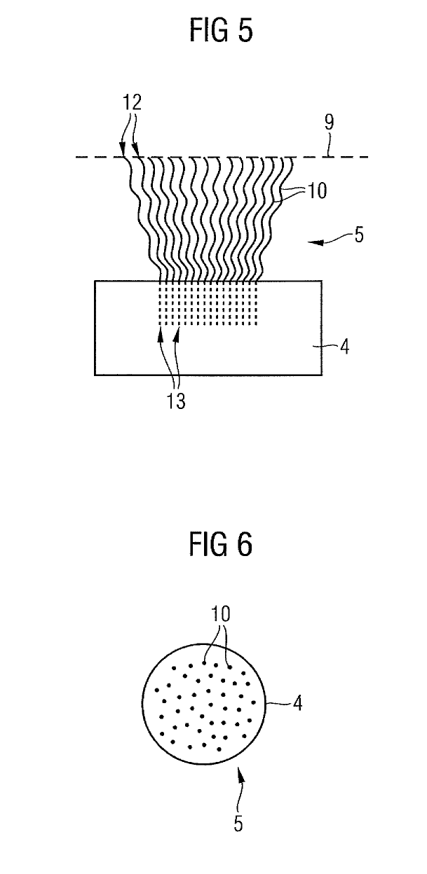

FIG. 6 shows a top view of one embodiment of a brush 5 with corrugated brush elements 10. Of the brush elements 10, only ends facing away from a mount 4 are illustrated. The mount 4 is cylindrical, like the brush 5. The corrugation of the brush elements 10 provides that the brush elements 10 are separated at the end facing away from the mount 4.

The brush elements 10 may be formed by carbon fibers or electrically conductive wires, for example.

The present embodiments may, for example, be used for computed tomography systems. The present embodiments are not, however, restricted to this area of use, but may be used for any technical application where a contact for transmitting current or data is to be effected between two parts or components moving relative to one another. An example of such an area of use would be automation engineering.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A brush for transmitting current at a sliding surface between gantry parts of a medical imaging system moving relative to one another, the brush comprising:
brush elements arranged such that the brush elements contact the sliding surface spaced apart from one another.

2. The brush as claimed in claim 1, wherein the brush elements are configured to be fiber-like, and
wherein each of the brush elements has a first end and a second end, the first ends being spaced apart from one another.

3. The brush as claimed in claim 1, further comprising a mount, in which the brush elements are arranged.

4. The brush as claimed in claim 2, further comprising a mount,
wherein the second ends are arranged in the mount.

5. The brush as claimed in claim 4, further comprising holes spaced apart from one another in the mount,
wherein the second ends are fixed in the holes.

6. The brush as claimed in claim 4, wherein the brush elements are corrugated.

7. The brush as claimed in claim 3, wherein the brush is cylindrical.

8. The brush as claimed in claim 3, wherein the brush is cuboidal.

9. A computed tomography system with a fixed gantry part and a rotatable gantry part, the computed tomography system comprising:
a brush for transmitting current at a sliding surface between the fixed gantry part and the rotatable gantry part moving relative to one another, the brush comprising:
brush elements configured such that the brush elements contact the sliding surface spaced apart from one another.

10. The computed tomography system as claimed in claim 9, wherein the brush elements are configured to be fiber-like, and
wherein each of the brush elements has a first end and a second end, the first ends being spaced apart from one another.

11. The computed tomography system as claimed in claim 9, further comprising a mount, in which the brush elements are arranged.

12. The computed tomography system as claimed in claim 10, further comprising a mount,
wherein the second ends are arranged in the mount.

13. The computed tomography system as claimed in claim 12, further comprising holes spaced apart from one another in the mount,
wherein the second ends are fixed in the holes.

14. The brush as claimed in claim 2, further comprising a mount, in which the brush elements are arranged.

15. The brush as claimed in claim 4, wherein the brush is cylindrical.

16. The brush as claimed in claim 5, wherein the brush is cylindrical.

17. The brush as claimed in claim 6, wherein the brush is cylindrical.

18. The brush as claimed in claim 4, wherein the brush is cuboidal.

19. The brush as claimed in claim 5, wherein the brush is cuboidal.

20. The brush as claimed in claim 6, wherein the brush is cuboidal.
